(19) United States
(12) Patent Application Publication
(10) Pub. No.: US 2020/0369497 A1
(43) Pub. Date: Nov. 26, 2020

(54) Rotary Winch

(71) Applicant: Paul C. Madsen, Chantilly, VA (US)

(72) Inventor: Paul C. Madsen, Chantilly, VA (US)

(21) Appl. No.: 16/869,287

(22) Filed: May 7, 2020

Related U.S. Application Data
(60) Provisional application No. 62/851,906, filed on May 23, 2019.

(51) Int. Cl. B66D 3/02

(52) U.S. Cl. CPC B66D 3/02

(57) ABSTRACT

Embodiments of a rotary winch includes a support arm, a winch assembly and a pulley arrangement arranged so as to facilitate effective pulling of heavy loads.

### CROSS-REFERENCE TO RELATED APPLICATIONS

The present application claims priority to U.S. provisional application No. 62/851,906, filed May 23, 2019, entitled “Rotary Winch”, the contents of which are incorporated by reference herein in their entirety.

### TECHNICAL FIELD

The present disclosure relates to winches, and more particularly to a winch operable to tension a line with a rotary drive, facilitating actions such as moving heavy, awkward and/or cumbersome items.

### BACKGROUND AND SUMMARY

Come-along devices are known to facilitate the dragging or moving of heavy loads, such as trees that are downed or are being downed. Such devices are hand-operated, and include a winch, a ratchet mechanism and a rope or cable wrapped around a winch drum. As the ratchet is cranked, the rope is increasingly wrapped around the drum, thereby creating tension on the other end of the rope, which typically employs a hook or similar device for attachment to the object being pulled. Come-along devices often require that the user be close to the item being pulled or in the line of the cable used to pull the load. Such operational environments pose risk of injury or worse to the user.

The present disclosure describes a rotary winch that can operate whereby the user places the device between an anchor point (such as a tree, vehicle or any secure, non-movable item), and the object that is to be moved (the load). The operator can secure the device to the anchor point, such as with a separate cable or strap and an anchor hook. The operator can then unspool the cable or rope to the desired length and attach it to the item to be moved. The operator can then grab the handle with one hand and proceed to rotate the hand crank in rotary fashion at the desired speed while standing at a safe distance from the high-tension cable. The handle can extend from a support arm that is secured at an angle such as ninety degrees to a pulley arrangement that incorporates the hook. The winch frame and drum can also be secured to the support arm. Since the cable is under high tension, the winch can include a safety gear release or tension release which prevents undesirable reverse rotation. When the object is moved to the correct location or has reached the desired tension, the cranking is stopped by the operator. The device's safety release can be activated to allow slack in the line or cable, and then the hook can be released from the item that was moved.

An alternative embodiment can incorporate an anchor hole in the pulley housing instead of an anchor hook. This allows use of a cable or rope that already has a hook attached. Other embodiments providing improvements over known devices are also disclosed herein.

### BRIEF DESCRIPTION OF THE DRAWINGS

FIGS. 1, 2 and 5 are perspective views of the rotary winch according to various embodiments of the present disclosure.

FIG. 3 is a perspective view of the rotary winch according to embodiments of the present disclosure positioned between an anchor and a load.

FIG. 4 is an exploded perspective view of an embodiment of a rotary winch according to the present disclosure.

### DETAILED DESCRIPTION OF EMBODIMENTS

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

It will be appreciated that reference to “a”, “an” or other indefinite article in the present disclosure encompasses one or more than one of the described element. Thus, for example, reference to a hook encompasses one or more hooks, reference to a gear encompasses one or more gears, reference to a handle encompasses one or more handles and so forth.

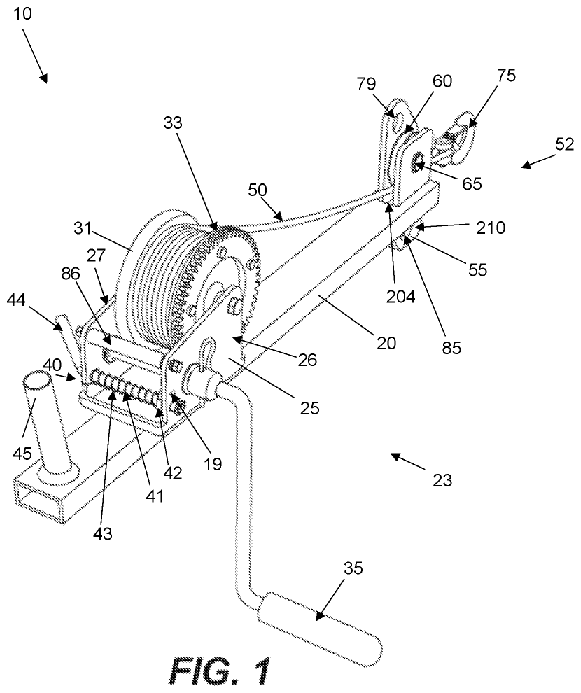

As shown in FIGS. 1 through 5, embodiments of the rotary winch 10 according to the present disclosure employ a support arm 20, a winch assembly 23, a cable 50 and a pulley arrangement 52. The winch assembly 23 can include a winch frame 25, a winch drum 30 and a gear latch and/or tension release element 40, for example. A hand crank 35 interacts with the winch assembly 23 to crank a cable 50 around the winch drum 30. A handle 45 on the support arm 20 can also be provided. The pulley arrangement 52 can include, for example, a pulley housing 55, a pulley 60, a pulley axle 65, an anchor hook 70 with anchor hook pin 72, and an object hook 75 with object hook pin 77 and/or object hook opening 79. In various embodiments, an anchor hole 85 can be provided in lieu of or in addition to the anchor hook 70. In further embodiments, an anchor hole 85, or the anchor hook 70, is provided directly in the support arm 20 instead of in the pulley housing 55.

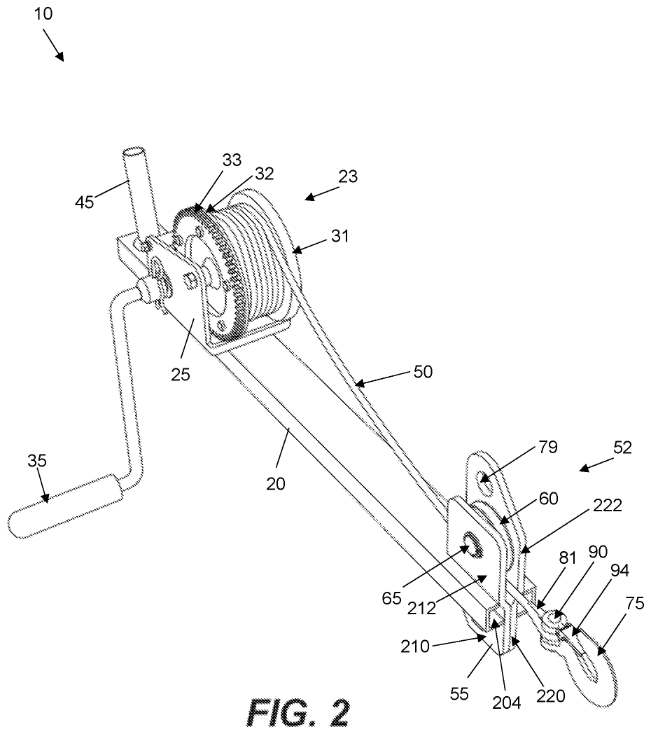

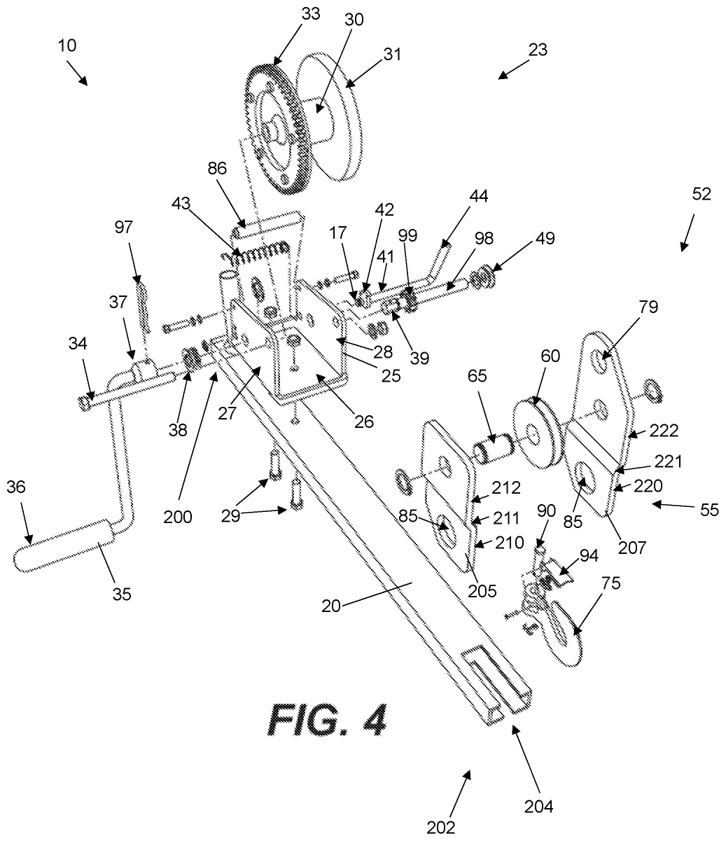

The support arm 20 can be secured to the pulley arrangement 52 by welding, bolts or similar attachment methods, for example. In various embodiments, the support arm 20 is secured to the pulley arrangement 52 at a ninety-degree angle so as to provide stable operation with commensurate mechanical advantage as well as to avoid placing the operator in the pathway of an object being pulled. The support arm 20 can be a rectangular prism (e.g., one inch by two-inch) formed of steel or similar material and can be hollow, solid or partially hollow. In various embodiments, the support arm 20 can be twenty to forty inches in fixed length or can be extendable such as with a telescoping interior segment that adapts as desired by the user. For example, a user may desire a longer support arm for comfort of operation or increased safety margin. The support arm 20 separates the winch assembly 23 from the pulley arrangement 52, allowing a safe offset from the cable/rope line under tension and providing a stable platform for winch cranking. As shown in FIG. 4, the support arm 20 can be formed with a first end 200 and a second end 202, wherein the second end 202 is formed with a gap 204 for receiving a portion of the pulley arrangement 52. For instance, the pulley housing 55 can be formed of opposing housing plates 205, 207. Housing plate 205 can be formed as a monolithic element, for example, with a lower wall 210, an intermediate angled wall 211 and an upper wall 212, wherein the intermediate angled wall 211 angles outwardly from the lower wall 210. Similarly, housing plate 207 can be formed as a monolithic element, for example, with a lower wall 220, an intermediate angled wall 221 and an upper wall 222, wherein the intermediate angled wall 221 angles outwardly from the lower wall 220. When assembled together, the lower walls 210, 220 of respective housing plates 205, 207 can abut one another in face-to-face mating relation, while the upper walls 212, 222 of respective housing plates 205, 207 are spaced apart so as to create room to receive pulley 60. The lower walls 210, 220 of the housing plates 205, 207 can be securely retained within the gap 204 of the support arm 20 as illustrated in FIGS. 1 and 4. As described elsewhere herein, securing the lower walls 210, 220 of the housing plates 205, 207 within the gap 204 can be by welding, bolts or other method. In various embodiments, the upper wall 222 of housing plate 207 extends further than the upper wall 212 of housing plate 205, which can assist in providing space for an object hook opening 79 as shown in FIG. 2, for example.

As shown in FIGS. 2 and 4, the load or object hook 75 can be provided with a pin 90 for receiving a loop 81 or other portion of cable 50. The pin 90 is releasably securable to a base of the object hook 75. The object hook 75 can further be provided with a movable latch 94 that can be opened and closed in order to provide access to the internal area of the hook for releasably retaining an object such as the cable 50 during operation. The securing of the pin 90 and latch 94 to the object hook 75 will be understood to those of skill in the art

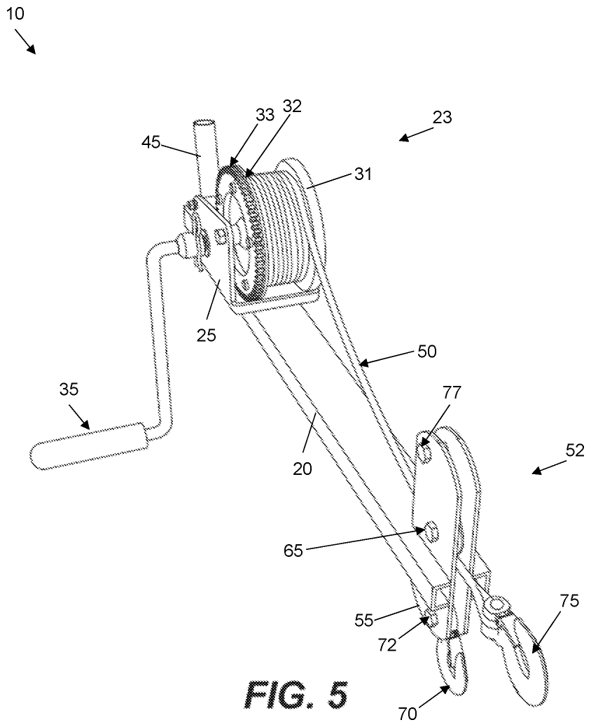

The winch assembly 23 can be provided in several forms in order to operate in accordance with the present disclosure. The winch frame 25 may be formed with a cross-sectional U-shape as shown in FIGS. 1 through 5 or may be provided with a rectangular cross-sectional shape so as to cover the top of the winch drum and side plates, for example. The winch frame 25 can be formed of a steel or similar material that supports the winch drum. In various embodiments, the approximate size of the winch frame 25 is six inches by four inches by four inches. Also, in various embodiments, the winch frame 25 is monolithically formed with a bottom wall 26 and two side walls 27, 28, wherein the bottom wall 26 is secured to the support arm 20 by bolts 29 or the like extending through the bottom wall 26, and wherein the side walls 27, 28 are formed with openings so as to accommodate the winch drum axle 34 and other elements as described hereinafter. The winch drum 30 can be formed of steel or similar material and is cylindrical in shape so as to allow winding of rope or cable. In various embodiments, the winch drum 30 is approximately two inches in diameter and three inches in length. Winch drum side plates 31, 32 are secured on both sides of the winch drum 30 and a drum gear 33 is secured to side plate 32 as shown in FIGS. 2 and 5 as will be understood to those skilled in the art. The winch drum 30 is rotatable about a drum axle or shaft 34 as shown in FIG. 4, wherein the drum shaft 34 is extendable through appropriate openings in the winch drum side plates 31, 32, gear 33, and winch frame side walls 27, 28. A support rod 86 can also be secured between the side walls 27, 28 of the winch frame 25 to maintain stability of the device during operation. An alternative embodiment of the winch assembly can be provided wherein the winch assembly is a brake winch that is fully automatic and self-locking such that when cranking stops, the load stops and is held in place automatically. When cranking starts, the line is tensioned for moving the load, for example.

The hand crank 35 is used for rotating the winch drum 30 and can be formed of steel or aluminum, for example. The hand crank 35 is capable of detaching from the winch assembly 23. As shown in FIG. 4, for example, the hand crank 35 has a handle end 36 and a crank end 37, wherein the crank end 37 is detachably securable to a drive gear axle end member 39 such as by a cotter pin 97 or other method. When the crank end 37 is secured about the drive gear axle or shaft 98, the hand crank 35 can crank the drive gear 99 directly, which rotates the drive gear axle or shaft and results in cranking of the drum gear 33 and thereby operates to ratchet the drum for winding the cable 50. Appropriate bushings and/or sleeves 38, 49 cooperate with the hand crank 35, drive gear shaft 98 and openings in the winch frame side walls 26, 27 to facilitate operation of the hand crank 35. In various embodiments, when detached from the drive gear axle end member 39, the crank end 37 of the hand crank 35 can be releasably secured around the end of the drum axle 34 so as to permit direct drive of the winch drum 30. In the embodiments shown in FIGS. 1 through 5, the hand crank 35 is positioned to drive the drive gear 99, and the drive gear 99 is engaged with the winch drum gear 33 for appropriate mechanical advantage. It will be appreciated that the drive gear 99 can be of various sizes for desired operation. It will be further appreciated that additional intermediate gears, drive shafts, and hand crank attachment points can be provided and secured to the winch frame 25 to vary the gear operation and associated mechanical advantages.

In various embodiments, a gear latch/tension release element 40 is provided as part of the winch assembly 23 and is used to release tension of the cable 50. The tension release element 40 prevents undesirable reverse rotation, which assists when the cable is under high tension, for example. The tension release element 40 is thus operable to prevent rotation of the winch drum gear 33 unless the hand crank 35 is rotating the winch drum gear 33. Tension release element 40 can include a rod 41 with a latch 42 and tension spring 43, wherein the rod has a rod handle 44. The rod latch 42 can be spring loaded to engage the drive gear 99 such that only a ratcheting motion in a desired direction of the winch drum 30 is permitted. In so doing, the drive gear 99 is prevented from rotating backwards. In other words, when the latch 42 is engaged with the drive gear 99, as the drive gear is rotated/ratcheted by the hand crank 35, the drive gear 99 drives the winch drum gear 33 and will be held in place after each crank. If the latch 42 is disengaged from the drive gear 99, the winch gear 33 is not held in place but can freely move in both forward (e.g., cable tensioning) and reverse (e.g., cable relaxing) directions. This freewheeling operation of the winch drum 30 may be desirable when decreasing tension or unspooling the cable 50. The latch 42 can be disengaged from the drive gear 99 by manually turning the rod handle 44 such as in a clockwise direction, which lifts the latch 42 off the drive gear 99 and permits free rotation. The rod 41 can be spring loaded via tension spring 43, which biases the rod 41 into the position where the latch 42 engages the drive gear 99. In various embodiments, the latch 42 is provided with an engaging nub (17 in FIG. 4) that is insertable through nub receptacle 19 in the winch frame 25 as shown in FIG. 1. The nub receptacle 19 holds the nub 17 in place and keeps the latch 42 from engaging the drive gear 99. When the rod handle 44 is pulled so as to remove the nub 17 from the opening 19, the spring 43 influences the latch 42 into a position of engagement with the drive gear 99, thereby preventing freewheeling rotation of the drive gear 99 and winch drum 30.

The support arm handle 45 can comprise a steel or similar material, and in various embodiments is approximately four to five inches long and one inch in diameter. The handle 45 can be used by the operator to provide stability to the end of the support arm 20. The handle 45 and winch frame 25 can be secured to the support arm 20 by welding, and the support arm 20 can be secured to the pulley housing 55 by welding, according to various embodiments of the present disclosure. The support arm handle 45 can extend from the support arm 20 at a ninety-degree angle or at an acute angle. In various embodiments, the support arm handle 45 is adjustable such as with an axle and pin so as to be movable to different angles to suit the user's preferences. Other embodiments can include handles of varying shapes and attachment points.

The cable 50 can be a synthetic rope or steel cable of various lengths depending upon the task. In various embodiments, the cable 50 is approximately fifty feet long and six mm in diameter. The cable is used to pull a load, and a lengthier cable also allows a user to stand well clear of a load being pulled. The cable 50 is secured at one end to the object hook 75 and at the other end to the winch drum 30. The object hook 75 can be secured within hole 79 or around pin 77 when not in use, or when the device 10 is to be used in conjunction with a snatch block pulley to increase mechanical advantage and load pulling power.

The pulley arrangement 52 includes a pulley housing 55, which can be formed of a steel or similar material. In various embodiments, the pulley housing 55 is approximately eight inches by three inches by one inch and houses the pulley 60. The pulley housing 55 allows for an angle change (e.g., ninety-degrees) of the cable on one end as it extends to the winch drum 30 and has an anchor point at the other end. The pulley 60 can be formed of steel or aluminum, for example, and can have a two to three-inch diameter. The pulley 60 allows the cable or rope to change direction during operation. The pulley axle 65 can be provided as a metal pin secured to the pulley housing 55 that provides an axis of rotation for the pulley 60. The pulley hook pins 72, 77 can be metal pins, for example, that provide anchor and attachment points for the hooks 70, 75, which can also be formed of metal. The anchor hook 70 can be secured via rope, chain, or strap, to a stabilizing object such as a heavy weight, a tree or other non-movable item. In lieu of an anchor hook, an anchor hole can be provided with an opening 85 in the housing walls 210, 220, which may allow a rope, anchor strap, anchor rope, anchor cable equipped with a hook or other anchoring device to be employed. The object hook 75 is secured to the object being pulled. When installed, the cable extends around a portion of the pulley. In various embodiments, the anchor hook 70 is retractable via a handle that can wind the anchor hook 70 around a shaft or pin 72.

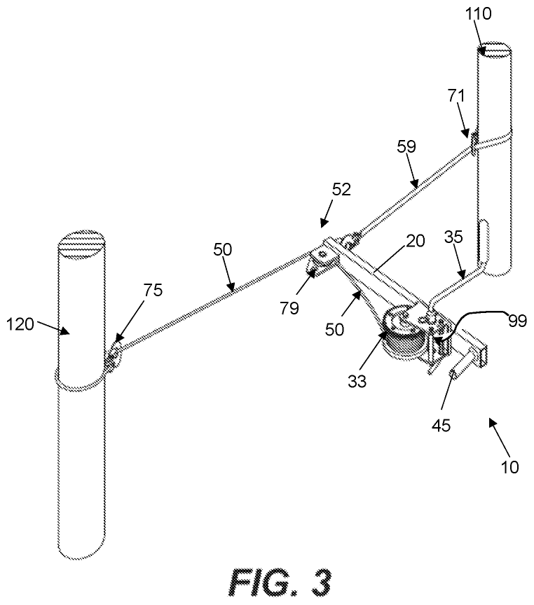

In operation, the device 10 can pull heavy loads with rope or cable by gaining mechanical advantage through gearing and rotary action and stability through an offset pulley mechanism. For example, as shown in FIG. 3, device 10 is provided, and an anchor strap clasp 71 is secured to an anchor such as post 110. The object hook 75 is secured to the object 120 being pulled. In the event the object 120 being pulled is a dead tree, preliminary cuts may be made in the lower portion of the tree to assist in felling the tree in a desired direction when the device 10 is employed. As can be seen in FIG. 3, the cable 50 is secured around the object 120 and within hook 75. Also, anchor strap 59 is secured around anchor 110 and within strap clasp 71. Once the strap clasp 71 and hook 75 are in place and the cable 50 and strap 59 are drawn taut, the user can ensure the hand crank 35 is securely engaged with drive gear 99 and winch drum gear 33, and can begin to rotate the crank 35. If the latch 42 of tension rod 41 is engaged with the drive gear 99, then the winch drum 30 will not reverse direction of rotation and will hold the position to which the winch drum 30 has been cranked. In other words, the device will allow braking of the load such that, when cranking stops, the load stops and the winch drum is held in place automatically. Should the user pull the rod handle 44 to release the tension, the winch drum 30 will be able to reverse direction and loosen the tension on the cable 50. Ultimately, the crank 35 can be rotated the desired amount to rotate the winch drum and spool the cable 50 in order to influence the desired movement of the object 120. When the object is moved to the correct location or has reached the desired tension, the cranking is stopped by the operator. The tension release element 40 can then be activated to allow slack in the line or cable, and then the hook can be released from the item that was moved.

Embodiments of the present disclosure thus provide, among other things, a portable unit that solves problems associated with quickly pulling heavy loads over longer distances. The device as presently disclosed provides a solution as described, for example, by utilizing rotary action and an offset support arm with winch. The rotary drive provides, among other things, a more fluid motion than the ratcheting action of prior come-along devices. This fluid motion increases cable retrieval speed which provides significant time savings during winching operation.

In addition, in the event of rope or cable failure, and unlike with current come-along devices, the offset support arm of the present device allows the operator to be located outside the path of a cable or rope that fails under high tension and snaps back towards the operator. Further, the present device's long support arm allows the operator to utilize the winch over a wider range of applications including both ground level and overhead operation, unlike existing devices that require the operator to be located very close to the device in order to get proper leverage for the ratcheting action.

The present device can be employed for a variety of operations, including tree tensioning for use when cutting down trees, warehouse use or farm use for moving heavy equipment, nautical use for moving boats and equipment, winching a stuck vehicle, tensioning cables or any application requiring pulling power of a rope or cable.

It will be appreciated that any and all dimensions described herein are exemplary and provided as embodiments associated with proper working operation of the present invention.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A rotary winch, comprising:
a support arm;
a winch assembly secured to the support arm, wherein the winch assembly comprises a winch drum and a winch gear;
a hand crank operable to engage the winch drum gear;
a pulley arrangement secured to the support arm;
a cable having first and second ends and engageable with the pulley arrangement, wherein the first end is secured to the winch drum, whereby rotation of the hand crank handle drives the winch drum gear and rotates the winch drum so as to wind or unwind the cable around the winch drum; and
a cable hook secured to the second end of the cable.

2. The winch of claim 1, wherein the winch assembly comprises a winch drum shaft comprising a first end releasably securable to the hand crank handle.

3. The winch of claim 1, further comprising a support arm handle secured to the support arm.

4. The winch of claim 3, wherein the support arm handle extends substantially perpendicularly from the support arm.

5. The winch of claim 1, wherein the pulley arrangement comprises:
a pulley housing secured to the support arm;
a pulley axle secured to the pulley housing; and
a pulley secured about the pulley axle for rotation within the pulley housing.

6. The winch of claim 5, wherein the cable extends around a portion of the pulley.

7. The winch of claim 5, wherein the pulley housing is formed with an opening for receiving the cable hook.

8. The winch of claim 1, wherein the support arm or pulley arrangement is formed with an anchor opening for receiving an anchoring device.

9. The winch of claim 8, wherein an anchor hook or anchor strap clasp is secured to the anchor opening.

10. The winch of claim 1, wherein an anchor hook is secured about an anchor hook pin, and wherein the anchor hook pin is secured to the pulley arrangement.

11. The winch of claim 9, wherein the anchor hook pin is rotatably secured to the pulley arrangement.

12. The winch of claim 1, wherein the winch assembly further comprises a drive gear shaft secured within a winch frame and a drive gear secured to the gear shaft, wherein the drive gear is engageable with the winch gear.

13. The winch of claim 12 wherein the hand crank is removably secured to the drive gear shaft.

14. The winch of claim 12, wherein the winch assembly further comprises a tension release element secured to the winch frame and operable to prevent rotation of the winch gear in a first direction.

15. The winch of claim 12, wherein the tension release element comprises a rod secured to the winch frame, a tension spring positioned about the rod and a latch secured to the rod, wherein the latch is engageable with the drive gear.

16. The winch of claim 1, wherein the winch assembly comprises a plurality of drive gears.

17. A rotary winch, comprising:
a support arm;
a winch frame secured to the support arm;
a winch drum shaft secured to the winch frame;
a winch drum secured about the winch drum shaft for rotation about the winch drum shaft;
a winch drum gear secured to the winch drum;
a drive gear shaft movably secured to the winch frame;
a drive gear secured to the drive gear shaft for rotation about the drive gear shaft, wherein the drive gear is engaged with the winch drum gear such that rotation of the drive gear rotates the winch drum gear;
a hand crank operable to selectively engage the drive gear and the winch drum gear;
an anchor hook secured to the support arm;
a cable hook; and
a cable having first and second ends, wherein the first end is secured to the cable hook and the second end is secured to the winch drum, whereby rotation of the hand crank rotates the winch drum so as to wind or unwind the cable around the winch drum.

18. The winch of claim 17, further comprising a tension release element secured to the winch frame and operable to prevent reverse rotation of the winch drum gear.

19. The winch of claim 18, wherein the tension release element comprises a nub and wherein the winch frame is formed with a nub receptacle, whereby when the nub is received within the nub receptacle, the winch drum gear can rotate in forward and reverse directions.

20. The winch of claim 17, further comprising a pulley arrangement, wherein the pulley arrangement comprises a pulley housing secured to the support arm, a pulley axle secured to the pulley housing and a pulley secured about the pulley axle for rotation between the pair of opposing pulley walls, and wherein the cable extends around a portion of the pulley.
